(19) United States
(12) Patent Application Publication
(10) Pub. No.: US 2024/0427974 A1
(43) Pub. Date: Dec. 26, 2024

(54) POWER EMULATION AND ESTIMATION

(71) Applicant: Micron Technology, Inc., Boise, ID (US)

(72) Inventor: Leon Zlotnik, Camino, CA (US)

(21) Appl. No.: 18/749,348

(22) Filed: Jun. 20, 2024

Related U.S. Application Data
(60) Provisional application No. 63/510,199, filed on Jun. 26, 2023.

(51) Int. Cl. G06F 30/3308; G06F 30/333; G06F 119/06

(52) U.S. Cl. CPC G06F 30/3308; G06F 30/333; G06F 2119/06

(57) ABSTRACT

An example method for power emulation and estimation includes estimating a functional power consumption value associated with a memory system by determining: a scan-based power estimation, scan-based power measurement, a calibration factor from correlating the scan-based power estimation to the scan-based power measurement and a correlated functional power using the calibration factor. The calibration factor can be applied to a functional power estimation in order to achieve better accuracy.

### PRIORITY INFORMATION

This application claims the benefits of U.S. Provisional Application No. 63/510,199, filed on Jun. 26, 2023, the contents of which are incorporated herein by reference.

### TECHNICAL FIELD

Embodiments of the disclosure relate generally to memory sub-systems, and more specifically, relate to memory power emulation and estimation

### BACKGROUND

A memory system can include digital logic and an associated power supply, voltage control, and clock control. In general, the power supply, voltage control, and/or clock control can change a voltage or frequency during operation of the digital logic.

### BRIEF DESCRIPTION OF THE DRAWINGS

The present disclosure will be understood more fully from the detailed description given below and from the accompanying drawings of various embodiments of the disclosure.

FIG. 1 illustrates an example memory sub-system for power emulation and estimation in accordance with some embodiments of the present disclosure.

FIG. 2 illustrates an example system for power emulation and estimation in accordance with some embodiments of the present disclosure.

FIGS. 3A-B illustrate an example diagram for a method of power emulation and estimation in accordance with some embodiments of the present disclosure.

FIG. 4 illustrates an example diagram for a method of power emulation and estimation in accordance with some embodiments of the present disclosure.

FIG. 5 illustrates an example method for power emulation and estimation in accordance with some embodiments of the present disclosure.

FIG. 6 is a block diagram of an example computer system in which embodiments of the present disclosure may operate.

### DETAILED DESCRIPTION

Aspects of the present disclosure are directed to power emulation and estimation. It can be beneficial to reduce power consumption in digital logic circuits. Memory systems may increasingly occupy more area in system-on-chips (SoCs). Power estimation can determine whether the memory device will meet targeted power specifications. In today's world, the electronics devices may have high transistor density. Thus, more interconnects between these elements may be used and accordingly the share of power consumed in the interconnections may increase compared to overall power consumption. As a result, additional cooling circuits may be employed and/or the component (e.g., battery) lifetime may be reduced. Power estimation can mitigate or avoid problems associated with additional cooling and reliability. For instance, power estimation may thereby determine the extent to which additional cooling may be needed to mitigate any reliability issues, etc. Accordingly, obtaining accurate power estimation is desirable.

Power consumption can be dependent on both the physical structures on a chip and the mode of operation. With today's multi-mode SoCs, determining the correct stimulus to verify average and peak power across a variety of modes is increasingly challenging. For more accurate power estimation, switching activity data can be obtained by simulating test cases with real system stimulus. Often, such simulation is not available until later in the design cycle. If the switching activity data is not available from simulation, an estimate of the switching activity on the chip's primary inputs can be made and the estimate can be applied within a power analysis tool. For instance, transient switching power can be estimated based on the number of flip-flops, combinatorial gates, and clock speed. Power emulation can extend the hardware emulation technique with power sensors and corresponding power models to gather estimated power analysis data of the design-under-test. Power estimation may also be referred to as early power analysis or power simulation and can be based on modelling. In some examples, it is possible to obtain activity vectors from the power emulation and apply it to the power analysis. In other examples, the power can be measured physically. The power estimation can be performed with or without switching activity inputs, although it can be inaccurate when vectorless. Either way, a particular switching activity profile for all nodes can play a key role in the final accuracy of the power estimation. Emulation can be performed using a field-programmable gate array (FPGA) or other discrete components or particular machines. It can be possible to obtain activity vectors from the power emulation and apply this to the power analysis. In other cases, the power can be measured physically. Either way, an exact switching activity profile for all nodes affects the final accuracy.

In some previous approaches, power consumption can be estimated by real or pseudo-gate level simulated power analysis alone. In some previous approaches, power consumption can be estimated by a functional pattern automated test equipment (ATE) power measurement. In some previous approaches, power consumption can be a direct or indirect power measurement. However, previous approaches can be inaccurate due to switching activity being hard to generate. Furthermore, it can be difficult to align different parts of the design in order to have peak activity at the same time. Early netlists can differ significantly from final ones. The model itself can have inaccuracies, etc. In emulation, the devices that emulate ASIC structures can be physically different. They can use different architecture, structure, processes and/or can have completely different power characteristics. Therefore, measuring the power emulated by them can be quite off target. As an example, these previous approaches can have limitations when trying to analyze or emulate only part of the design.

To address the above and other deficiencies, approaches herein estimate the functional power consumption value associated with a system by calibrating pre-versus post-silicon (Si) power figures. The calibration can use a plurality of vectors from a scan pattern simulation. The scan-based power estimation can use scan vectors from a scan pattern simulation. As an example, the functional power estimation can be determined and a calibration factor can be used to modify the functional power estimation without using a full physical design to do so, and yet yield an accurate estimation. In this way, the estimation from a simulation based on the functional vector can be modified using the calibration factor and is more accurate in the absence of using a full physical design. The following description demonstrates in more detail how this calibration factor is determined.

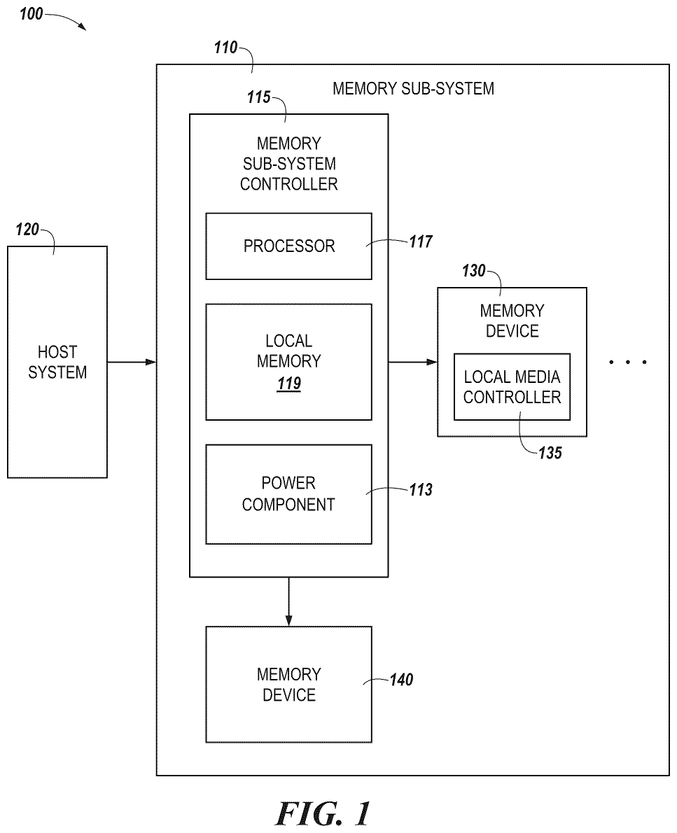

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the PCIe interface. The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via the same communication connection, multiple separate communication connections, and/or a combination of communication connections.

The memory devices 130, 140 can include various combinations of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) includes Not-AND (NAND) type flash memory and write-in-place memory, such as a three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130, 140 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLC) can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as three-dimensional cross-point arrays of non-volatile memory cells and NAND type memory (e.g., 2D NAND, 3D NAND) are described, the memory device 130 can be based on any other type of non-volatile memory or storage device, such as such as, read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically crasable programmable read-only memory (EEPROM).

The memory sub-system controller 115 (or controller 115 for simplicity) can communicate with the memory devices 130, 140 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device 130 and/or the memory device 140. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address, physical media locations, etc.) that are associated with the memory devices 130. The memory sub-system controller 115 can further include host interface circuitry to communicate with the host system 120 via the physical host interface. The host interface circuitry can convert the commands received from the host system into command instructions to access the memory device 130 and/or the memory device 140 as well as convert responses associated with the memory device 130 and/or the memory device 140 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory device 130 and/or the memory device 140.

In some embodiments, the memory device 130 includes local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller (e.g., local media controller 135) for media management within the same memory device package. An example of a managed memory device is a managed NAND (MNAND) device.

The memory sub-system 110 includes a power component 113 that can be configured to orchestrate and/or perform operations related to power emulation and estimation and can use various components, data paths, and/or interfaces of the memory sub-system 110 to be enabled to do so. The power component 113 can include various circuitry to facilitate power emulation and estimation and control the scanning and transfer of data from and to the memory cells of the memory devices 130, 140 in order to do so. For example, the power component 113 can include a special purpose circuitry in the form of an ASIC, FPGA, state machine, and/or other logic circuitry or software and/or firmware that can allow the power component 113 to orchestrate and/or perform data storage operations related to programming memory cells in order to emulate and/or estimate power and communicate to various components, data paths, and/or interfaces of the memory sub-system 110.

The power component 113 can be communicatively coupled to the memory devices 130, 140 and can access the memory device 130, the memory device 140, internal data paths of the memory sub-system 110, and/or interfaces of the memory sub-system 110 to perform the operations described herein and/or to transfer storage data to additional elements of the memory sub-system 110.

In some embodiments, the memory sub-system controller 115 includes at least a portion of the power component 113. For example, the memory sub-system controller 115 can include a processor 117 (processing device) configured to execute instructions stored in local memory 119 for performing the operations described herein. In some embodiments, the power component 113 is part of the host system 120 (not illustrated), an application, or an operating system.

The memory devices 130, 140 in FIG. 1 can include a number of physical blocks in accordance with some embodiments of the present disclosure. For example, the memory devices 130, 140 can include a NAND flash memory array including the number of physical blocks. However, embodiments of the present disclosure are not limited to a particular type of memory or memory array. For example, the memory array can be a DRAM array, an RRAM array, or a PCRAM array, among other types of memory arrays. Further, the memory array can be located on a particular semiconductor die along with various peripheral circuitry associated with the operation thereof.

The memory cells of the memory array can be mixed mode cells operable as SLCs and/or XLCs (e.g., extra-level cells which can refer to cells operable at a level greater than SLCs, also referred to as non-SLC mode cells, where tri-level-cells (TLC) and quad-level-cells (QLC) are non-SLC mode cells). The number of physical blocks in the memory array can be 128 blocks, 512 blocks, or 1,024 blocks, but embodiments are not limited to a particular multiple of 128 or to any particular number of physical blocks in the memory array. Further, different portions of memory can serve as a dynamic SLC cache for media management operations, such as garbage collection. For example, different portions of memory can be dynamically increased and/or decreased in size as demands on the memory are increased and/or decreased to allow garbage collection to more efficiently address these demands.

Each physical block of the memory array can contain a number of physical rows of memory cells coupled to access lines (e.g., word lines). The number of rows (e.g., word lines) in each physical block can be 32, but embodiments are not limited to a particular number of rows per physical block. Further, the memory cells can be coupled to sense lines (e.g., data lines and/or digit lines).

Each row can include a number of pages of memory cells (e.g., physical pages). A physical page refers to a unit of programming and/or sensing (e.g., a number of memory cells that are programmed and/or sensed together as a functional group). Each row can comprise one physical page of memory cells. However, embodiments of the present disclosure are not so limited. For instance, in a number of embodiments, each row can comprise multiple physical pages of memory cells (e.g., one or more even pages of memory cells coupled to even-numbered bit lines, and one or more odd pages of memory cells coupled to odd numbered bit lines). Additionally, for embodiments including XLCs, a physical page of memory cells can store multiple pages (e.g., logical pages) of data, for example, an upper page of data and a lower page of data, with each cell in a physical page storing one or more bits towards an upper page of data and one or more bits towards a lower page of data.

In a non-limiting example, an apparatus (e.g., the computing system 100) can include a memory sub-system power component 113 (or “power component” for brevity). The memory sub-system power component 113 can be resident on the memory sub-system 110. As used herein, the term “resident on” refers to something that is physically located on a particular component. For example, the memory sub-system power component 113 being “resident on” the memory sub-system 110 refers to a condition in which the hardware circuitry that comprises the memory sub-system power component 113 is physically located on the memory sub-system 110. The term “resident on” can be used interchangeably with other terms such as “deployed on” or “located on,” as referred to herein.

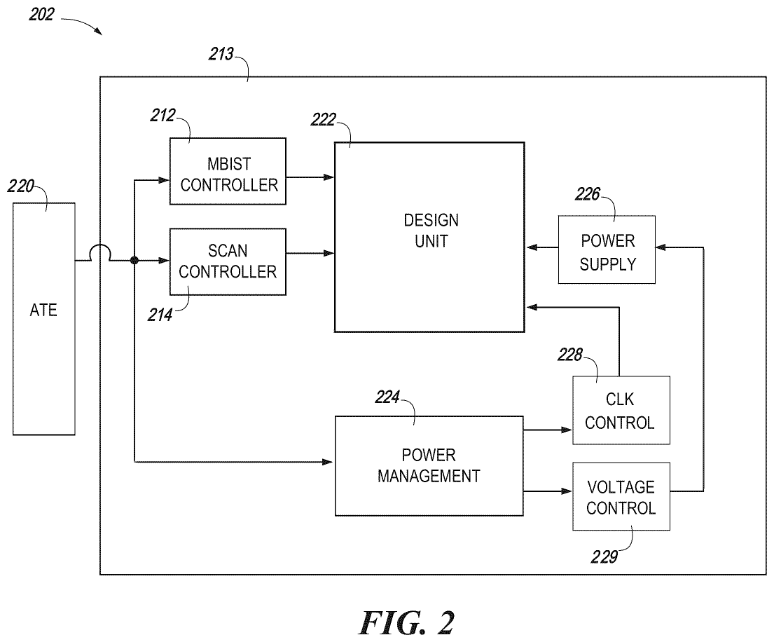

FIG. 2 illustrates an example system 202 for power emulation and estimation in accordance with some embodiments of the present disclosure. The system 202 can include an automatic testing equipment (ATE) component 220 and a power component 213 (e.g., such as power component 113 in FIG. 1). In some examples, the power component 213 can be a system on chip (SoC). A component, such as the ATE component 220 described herein, can include various circuitry to facilitate an operation associated with the component, e.g., testing a portion of a memory system (such as memory sub-system 110 in FIG. 1). For example, the ATE component 220 can include special purpose circuitry in the form of an ASIC, FPGA, state machine, and/or other logic circuitry or software and/or firmware that can allow the ATE component 220 to test other components and/or parameters of the memory sub-system. As an example, the ATE component 220 can be a simple computer-controlled digital multimeter, or a complicated system containing dozens or more complex test instruments (real or simulated electronic test equipment) capable of automatically testing and diagnosing faults in sophisticated electronic packaged parts or on wafer testing, including systems on chips and/or integrated circuits. While the example associated with FIG. 2 can be used for power estimation, it may be more difficult to estimate the power using an active clock and voltage control that may be changing the power figures. In some examples, the models for intermediate voltages may not even be available.

Further, in some examples, the power component 213 can be an application-specific-integrated circuit (ASIC), a field-programmable gate array (FPGA), etc. The power component 213 includes a design unit 222 and a power management controller 224. The power management controller 224 can apply dynamic and adjustable parameters in order to control the performance and power consumption. The design unit 222 includes circuitry which can include one or more cores (e.g., “intellectual property (IP) cores”). As used herein, a “core” or “IP core” generally refers to one or more blocks of data and/or logic that form constituent components of an application-specific integrated circuit or field-programmable gate array. In some examples, the power management controller 224 can be a power management integrated circuit (or PMIC) used for managing power of the system 202. Although PMIC can refer to a wide range of chips (or modules in system on a chip (SoC) devices), most include several DC/DC converters. A DC-to-DC converter is an electronic circuit or electromechanical device that converts a source of direct current (DC) from one voltage level to another. It is a type of electric power converter. A PMIC is often included in battery-operated devices such as mobile phones and portable media players to decrease the amount of space required.

The ATE component 220 communicates with the design unit 222 through an MBIST (“memory built-in self-test”) controller 212 and/or a scan controller 214 (such as an AC scan controller, a DC scan controller, among other types of scan controllers). While an MBIST controller 212 is being described herein, embodiments are not so limited. For example, MBIST is just an example self-test and any number of self-test circuits can be used. The scan controller 214 can refer to circuitry and/or control logic that is used to control and manage a scan (e.g., an AC scan, a DC scan, etc.) as will be described further below. MBIST can refer to the industry-standard method of testing embedded memories. MBIST operates by performing sequences of reads and writes to the memory according to a test algorithm. Many industry-standard test algorithms exist. An MBIST controller generates the correct sequence of reads and writes to all locations of the memory (e.g., such as a random access memory (RAM)) to ensure that the cells are operating correctly. In doing this, some additional test coverage is achieved in the address and data paths that the MBIST uses. In addition, the design unit 222 can communicate with the power management controller 224 through a clock (“CLK”) control component 228 and a voltage control component 229 that is in communication with a power supply 226. The voltage control component 229 can control the voltage of the power supply 226 according to instructions received from the power management controller 224. In some examples, the power management controller 224 can be a power management integrated circuitry (PMIC).

The clock control component 228 can include various circuitries and/or logic inserted on the power component 213 for controlling clocks. The clock control component 228 can scale a clock timing according to instructions received from the power management controller 224. Further, since AC (at-speed) testing generally requires two or more clock pulses in capture mode with a frequency equal or substantially close to the functional clock frequency, without the clock control component 228, the at-speed pulses related to the ATE component 220 may need to be provided through the input/output (I/O) pads of the system (e.g., memory sub-system 110 in FIG. 1.). However, these I/O pads can have limitations in terms of the maximum frequency they can support. The clock control component 228, on the other hand, can use, in some examples, an internal phase-lock-loop (PLL) clock for generating clock pulses for test and/or, in other examples, an internal delay-locked-loop (DLL) clock for generating the clock pulses for test. While the clock control component 228 is described as providing clock timing for the ATE component 220 and also the clock timing according to instructions received from the power management controller 224, embodiments are not so limited. For example, the clock control component 228 can be used for scaling the frequency according to instructions from the power management controller 224 to dynamically adjust the frequency to the matching voltage (Dynamic or Adaptive Voltage-Frequency Scaling) and a different clock control component (not illustrated) can be used solely for the ATE component 220 and for clock timing of the ATE testing itself. Further, the clock control component 228 can be used for operation in a functional mode, as will be described further below, and the testing in conjunction with the ATE component 220 can reuse some elements of the clock control component 228 or other such structures.

In some examples, the PLL clock can refer to circuitry and/or logic that generates an output signal whose phase is related to the phase of an input signal. Although there are several different types of PLL clock circuits, the simplest is an electronic circuit consisting of a variable frequency oscillator and a phase detector in a feedback loop. The oscillator generates a periodic signal, and the phase detector compares the phase of that signal with the phase of the input periodic signal, adjusting the oscillator to keep the phases matched. Keeping the input and output phase in lock step also implies keeping the input and output frequencies the same. Consequently, in addition to synchronizing signals, a phase-locked loop can track an input frequency, or it can generate a frequency that is a multiple of the input frequency. These properties are used for computer clock synchronization, demodulation, and frequency synthesis.

In the other examples, the delay-locked-loop (DLL) can be a digital circuit similar to a phase-locked loop (PLL), with the main difference being the absence of an internal voltage-controlled oscillator, replaced by a delay line. A DLL can be used to change the phase of a clock signal (a signal with a periodic waveform), usually to enhance the clock rise-to-data output valid timing characteristics of integrated circuits (such as DRAM devices). DLLs can also be used for clock recovery (CDR). From the outside, a DLL can be seen as a negative-delay gate placed in the clock path of a digital circuit. The main component of a DLL can be a delay chain composed of many delay gates connected output-to-input. The input of the chain (and thus of the DLL) is connected to the clock that is to be negatively delayed. A multiplexer can be connected to each stage of the delay chain and the selector of this multiplexer can be automatically updated by a control circuit to produce the negative delay effect. The output of the DLL can be the resulting, negatively delayed clock signal.

Phase-locked loops can be widely employed in radio, telecommunications, computers, and other electronic applications. They can be used to demodulate a signal, recover a signal from a noisy communication channel, generate a stable frequency at multiples of an input frequency (frequency synthesis), or distribute precisely timed clock pulses in digital logic circuits such as microprocessors. Since a single integrated circuit can now provide a complete phase-locked-loop building block, the technique can be widely used in modern electronic devices, with output frequencies from a fraction of a hertz up to many gigahertz. Further, while phase-locked-loops (PLLs) and delay-locked-loops (DLLs) are provided in these examples, embodiments are not so limited. For example, any circuit capable of generating the clock or changes in frequency can be used.

In some embodiments, the system 202 can be deployed on, or otherwise included in a memory system (e.g., a storage device, a memory module, or a hybrid of a storage device and memory module). Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

In other embodiments, the system 202 can be deployed on, or otherwise included in a computing device such as a desktop computer, laptop computer, server, network server, mobile computing device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device. As used herein, the term “mobile computing device” generally refers to a handheld computing device that has a slate or phablet form factor. In general, a slate form factor can include a display screen that is between approximately 3 inches and 5.2 inches (measured diagonally), while a phablet form factor can include a display screen that is between approximately 5.2 inches and 7 inches (measured diagonally). Examples of “mobile computing devices” are not so limited, however, and in some embodiments, a “mobile computing device” can refer to an IoT device, among other types of edge computing devices.

Such computing devices can include a host system that is coupled to a memory system (e.g., one or more storage devices, memory modules, or a hybrid of a storage device and memory module). A host system can include a processor chipset and a software stack executed by the processor chipset. The processor chipset can include one or more cores, one or more caches, a memory controller (e.g., an SSD controller), and a storage protocol controller (e.g., PCIe controller, SATA controller). The host system uses the storage device, the memory module, or a hybrid of the storage device and the memory module, for example, to write data to the storage device, the memory module, or the hybrid of a storage device and memory module and read data from the storage device, the memory module, or the hybrid of a storage device and memory module.

In these examples, the host system can include a processing unit such as a central processing unit (CPU) that is configured to execute an operating system. In some embodiments, the processing unit can execute a complex instruction set computer architecture, such an x86 or other architecture suitable for use as a CPU for a host system.

A host system can be coupled to a memory system via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system and the memory system. The host system can further utilize an NVM Express (NVMe) interface to access components when the memory system is coupled with the host system by the PCIe interface. The physical host interface can provide an interface for passing control, address, data, and other signals between the memory system and the host system. In general, the host system can access multiple memory sub-systems via a same communication connection, multiple separate communication connections, and/or a combination of communication connections.

A memory system can include any combination of the different types of non-volatile memory devices and/or volatile memory devices. The volatile memory devices can be, but are not limited to, random access memory (RAM), such as dynamic random-access memory (DRAM) and synchronous dynamic random access memory (SDRAM).

Some examples of non-volatile memory devices include negative-and (NAND) type flash memory and write-in-place memory, such as three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Although non-volatile memory components such as three-dimensional cross-point arrays of non-volatile memory cells and NAND type memory (e.g., 2D NAND, 3D NAND) are described, the memory device can be based on any other type of non-volatile memory or storage device, such as such as, read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically crasable programmable read-only memory (EEPROM).

A memory system can also include additional circuitry or components. In some embodiments, a memory system can include a cache or buffer (e.g., DRAM) and address circuitry (e.g., a row decoder and a column decoder) that can receive an address from the memory system controller and decode the address to access the memory device(s). In some embodiments, memory devices can include local media controllers that operate in conjunction with a memory system controller to execute operations on one or more memory cells of the memory devices. For example, an external controller can externally manage the memory device (e.g., perform media management operations on the memory device). In some embodiments, a memory device is a managed memory device, which is a raw memory device combined with a local controller for media management within the same memory device package. An example of a managed memory device is a managed NAND (MNAND) device. Although non-limiting examples herein are generally described in terms of applicability to memory sub-systems and/or to memory devices, embodiments are not so limited, and aspects of the present disclosure can be applied as well to a system-on-a-chip, computing sub-system, data collection and processing, storage, networking, communication, power, artificial intelligence, control, telemetry, sensing and monitoring, digital entertainment and other types of system/sub-system and/or devices. Accordingly, aspects of the present disclosure can be applied to these components in order to provide power emulation and estimation, as described herein.

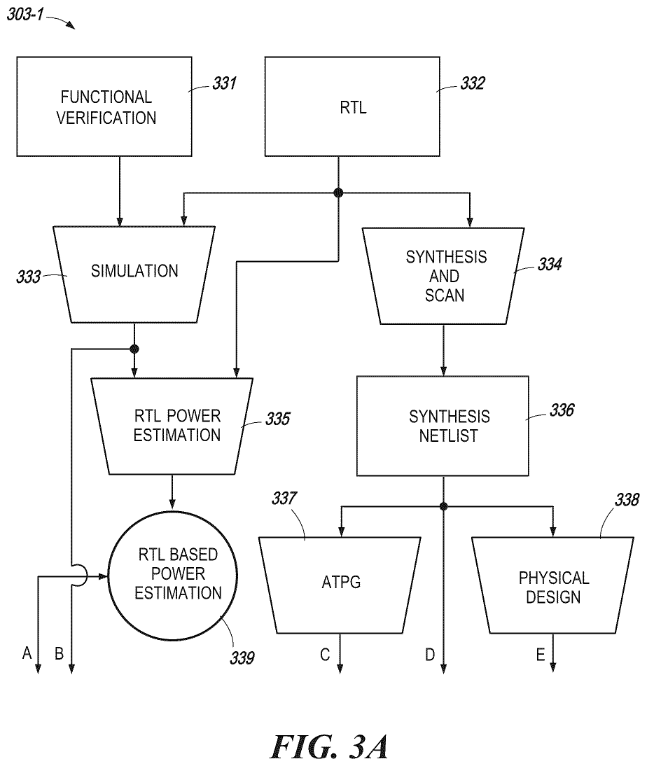

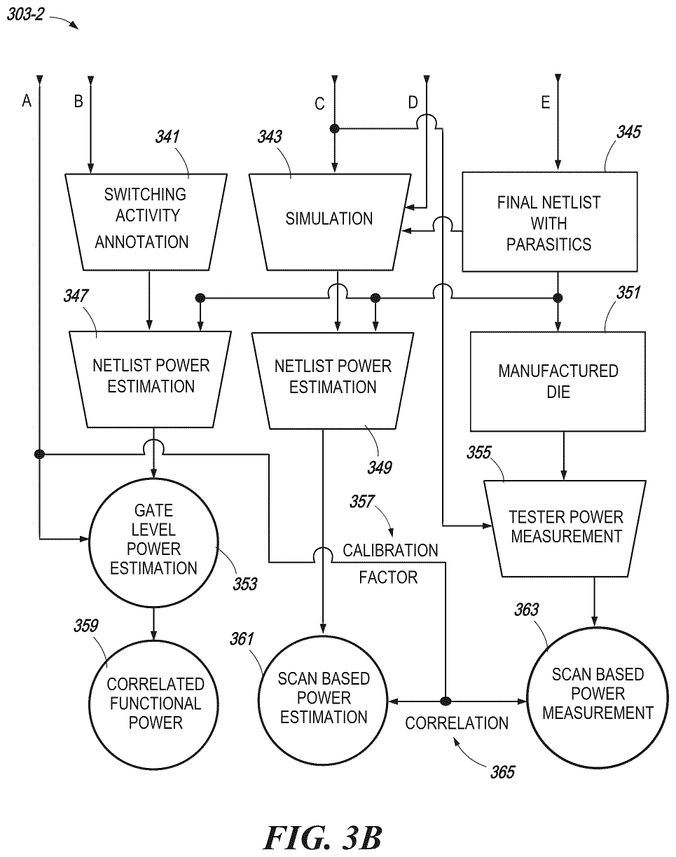

FIGS. 3A-B illustrate example diagrams 303-1, 303-2 for a method of power emulation and estimation in accordance with some embodiments of the present disclosure. For case of illustration since the overall diagram is larger than can be illustrated on a single page, each of FIGS. 3A-3B is a portion of the diagram and the letters A through E indicate a connection that leads to the other respective figure. For example, “A” in diagram 303-1 of FIG. 3A connects to “A” in diagram 303-2 of FIG. 3B, and so forth. Further, as will be described further below, the square boxes (such as the square box labeled “FUNCTIONAL VERIFICATION” 331) illustrate inputs (such as code) or objects used in the power estimation and emulation. The trapezium (or upside-down trapezoids) shape (such as trapezium-shaped “SIMULATION” 333) illustrates tools and/or processes used during the estimation and emulation steps. The circles (such as circle “RTL BASED POWER ESTIMATION” 339, e.g., RTL based functional power estimation) illustrate results or reports generated using the inputs and tools mentioned previously.

The following description of FIGS. 3A-B describes a process for determining a calibration factor 357. The calibration factor 357 can be applied to a gate level functional power estimation 353 (e.g., gate level functional power estimation), yielding a more accurate gate level functional power estimation 353 and therefore a more accurate correlated functional power 359 (e.g., the final functional power estimation). The correlated functional power 359 refers to the power consumption of the digital logic circuit when performing a specific function or operation. The correlated functional power 359 represents the dynamic power consumed by a circuit when it is switching between logic states, e.g., from 0 to 1 or 1 to 0, during a particular operation or functional mode. Further, the calibration factor 357 can be applied to the RTL based functional power estimation 339, yielding a more accurate RTL based functional power estimation 339. Subsequent performance of the system can use the calibration factor 357 and the RTL based functional power estimation 339 to be more accurate than using the RTL based functional power estimation 339 alone. Likewise, using the calibration factor 357 with the gate level functional power estimation 353 can be more accurate than using the gate level functional power estimation 353 alone.

The example diagram 303-1 of the power emulation and estimation method can include an input from functional verification 331 and a design abstraction referred to as a register transfer level (RTL) 332. Functional verification 331 can refer to the task of verifying that the logic design conforms to specification. Put another way, functional verification 331 attempts to answer the question “Does this proposed design do what is intended?” Functional verification can be a part of what is referred to as design verification, which, besides functional verification, considers non-functional aspects like timing, layout and power.

Functional verification 331 can include methods such as logic simulation, simulation acceleration, emulation, formal verification, intelligent verification, and/or HDL-specific versions of lint and other heuristics. Simulation acceleration refers to applying special purpose hardware to the logic simulation problem. Emulation refers to building a version of a memory system using programmable logic. Formal verification can refer to proving mathematically that certain requirements (also expressed formally) are met, or that certain undesired behaviors (such as deadlock) cannot occur. Intelligent verification can use automation to adapt the testbench to changes in the register transfer level code. HDL-specific versions of lint, and other heuristics, can be used to find common problems. The functional verification 331 includes inputs (such as code) that can be used to direct functional switching activity vectors during a simulation 333, as will be described below. These vectors may be in any format that power estimation tools can read, such as value change dump (VCD), fast signal database (FSDB), and so forth.

The RTL 332 can refer to a design abstraction that models a synchronous digital circuit in terms of the flow of digital signals (data) between hardware registers, and the logical operations performed on those signals. The RTL 332 based power estimation can be a first approach and can run using both the RTL 332 and activity vectors. The RTL 332 can also be used by the synthesis and scan 334 tool, as will be described below, where the RTL 332 can be mapped into gates and have scan chains inserted. The RTL 332 can be used in hardware description languages (HDLs) like Verilog and VHDL to create high-level representations of a circuit, from which lower-level representations and ultimately actual wiring can be derived. Design at the RTL level is typical practice in modern digital design. Unlike in software compiler design, where the register-transfer level (RTL) is an intermediate representation and at the lowest level, the RTL level can be an input that digital designers use to operate on. Further, in synthesis, an intermediate language between the input RTL representation and the target netlist can be used (as will be described below). Unlike in netlist, constructs such as cells, functions, macros, and multi-bit registers are available.

As an example, a synchronous circuit can include two kinds of standard cell elements: registers (Sequential logic) and combinational logic. Registers (usually implemented as D flip-flops) synchronize the circuit's operation to the edges of the clock signal, and are some of the sequential elements such as flip-flops, latches, register files, etc. in the circuit that have memory properties. Combinational logic can perform all the logical functions in the circuit and can include logic gates, buffers, shifters, isolation cells, among many other elements. When designing digital integrated circuits with a hardware description language (HDL), the designs can be engineered at a higher level of abstraction than transistor level (logic families) or logic gate level. In HDLs, the designer can determine the registers (which can correspond to variables in computer programming languages), and can describe the combinational logic by using constructs that are familiar from programming languages such as if-then-else and arithmetic operations. This level is called register-transfer level (RTL). The term refers to the fact that RTL focuses on describing the flow of signals between registers.

Outputs from the functional verification 331 and the RTL 332 can be used as inputs to a simulation 333. The simulation (e.g., logic simulation) 333 can refer to the use of simulation software to predict the behavior of digital circuits and hardware description languages. The simulation 333 can be performed at varying degrees of physical abstraction, such as at the transistor level, gate level, the RTL 332, electronic system-level (ESL), or behavioral level. Simulation 333 may be used as part of the verification process in designing hardware. Simulations have the advantage of providing a familiar look and feel to the user in that it is constructed from the same language and symbols used in design. By allowing the user to interact directly with the design, simulation 333 is a natural way for the designer to get feedback on their design. The simulation 333 can provide switching activity that is used as an input into the RTL power estimation 335. In order to be used with a gate level functional power estimation, the switching activity can be annotated, as shown as the switching activity annotation 341. The resulting annotated switching activity can be used as a basis for the netlist power estimation 347. As an example, in order to be used in the netlist power estimation 347, the switching activity from the simulation 333 is first annotated (or, in other words, translated) from the RTL design structure to be usable with the gate-level (netlist) structure. The netlist power estimation 347 can ultimately be used to determine a power estimation 353. Further, the RTL power estimation 335 can be used to determine a final RTL based functional power estimation 339.

The synthesis and scan 334 tool or process can include mapping the inputs of the RTL 332 into gates and inserting scan chains. The output of the synthesis and scan 334 can comprise synthesis netlist 336. The synthesis netlist 336 is an object generated by the procedure of the synthesis and scan 334 (where procedures are represented by the trapezium shape). A netlist refers to a description of the connectivity of an electronic circuit. In its simplest form, a netlist includes a list of electronic components in a circuit and a list of the nodes they are connected to. A network (net) is a collection of two or more interconnected components. The structure, complexity, and representation of netlists can vary, but at least one purpose of a netlist is to convey connectivity information. Netlists can provide instances, nodes, and perhaps some attributes of the components involved. In some examples, if they express much more than this, they are usually considered to be a hardware description language such as Verilog or VHDL, or one of several languages specifically designed for input to simulators or hardware compilers (such as SPICE analog simulation netlists). While the synthesis netlist 336 includes the gates and scans, the synthesis netlist 336 does not have all of the routing, wires, or clock buffering infrastructure.

The synthesis netlist 336 can provide information about the inputs and outputs of a circuit, providing a description of a digital logic circuit that specifies its connections and logic functions of its components. The synthesis netlist 336 can be an intermediate step in the process of designing a digital circuit, where a high level description of the circuit is first transformed into a lower level netlist that can be used to implement the design in hardware. The synthesis netlist 336 includes information about the inputs and outputs of the circuit, as well as the logical functions performed by each of its components, such as gates, flip-flops, and other digital logic elements. The synthesis netlist 336 may also include other details such as annotations to indicate timing constraints, power optimization, and area constraints.

The physical design 338 process involves mapping the logical elements and connections of the circuit to specific components and connections on a chip or board. During physical design 338, the synthesis netlist 336 is transformed into a final (e.g., physical) netlist that represents the actual interconnections between the components of the digital circuit. This involves placing and routing (e.g., referred to as “P & R” or place and route) the components on the chip or board taking into account factors such as physical size constraints, signal integrity, power consumption, design rules, reliability, and/or other factors. While the synthesis netlist 336 usually does not assign specific coordinates to gates since it uses abstract wires without exact lengths and/or traces, the P&R process places the gates (i.e., assigns the exact coordinates to the gates) and inserts the clock tree (through a buffered clock structure) and processes all the physical wire connections (e.g., the “routing”). Subsequent to the placing and routing, the physical netlist is then physical rather than abstract. Each of the respective cells has exact coordinates and is connected to the power grid, with wires that correspond to exact width, length, via, and trace, etc. The physical netlist is then used to generate fabrication masks that are used in the manufacturing process of the chip or board. These masks define the exact positions and shapes of the components on the chip, as well as the interconnections between them.

The synthesis netlist 336 can be used as an input to an automatic test pattern generator (ATPG) 337. The ATPG 337 can generate vectors to be used by a tester to test the manufactured product. The ATPG 337 can refer to an electronic design automation method or technology used to find an input (or test) sequence that, when applied to a circuit, enables automatic test equipment to distinguish between the correct circuit behavior and the faulty circuit behavior caused by defects. The generated patterns (e.g., high or low power patterns) are used to test semiconductor devices after manufacture, or to assist with determining the cause of failure (e.g., failure analysis). The effectiveness of the ATPG 337 can be measured by the number of modeled defects, or fault models, that are detectable, by the number of generated patterns, and/or by the test coverage that can reach a particular threshold (e.g., approximately 99%). These metrics generally indicate test quality (higher with more fault detections) and test application time (higher with more patterns). ATPG efficiency is another important consideration that is influenced by the fault model under consideration, the type of circuit under test (full scan, synchronous sequential, or asynchronous sequential), the level of abstraction used to represent the circuit under test (gate, register-transfer, switch), and the required test quality.

The ATPG 337 tool can read the synthesis netlist 336 and generate scan patterns. As an example, this stage involving the ATPG 337 tool may be highly customizable. For example, patterns can be generated to create high or low power patterns, quantity of patterns per chain, quantity of chains per pattern, patterns based on clock criteria (e.g., a clock value, a clock speed, a clock domain), a quantity of power domains, patterns based on a power domain, or any combination thereof. The ATPG 337 can provide a series of scan patterns to be used by a simulation 343. The simulation 343 can also use inputs from the synthesis netlist 336 and the final netlist with parasitics 345. The result of the simulation 343 can be used as a basis for the netlist power estimation 349. The netlist power estimation 349 can be used to determine a scan based power estimation 361 which is based on the power consumed by the device when scanned as the consumed power is based on the final netlist with parasitics 345 and simulated switching activity. The physical design 338 can result in an output of a final netlist with parasitics 345 that includes an appropriate parasitic extraction corresponding to a particular netlist level power estimation. The final netlist is a netlist that is based on the complete physical design 338 of a circuit, including all the details of its components, connections, and timing characteristics, in addition to PLLs and/or PHYs, among other components. In contrast to the synthesis netlist 336, which is a logical representation of the circuit, the final netlist is a physical representation of the circuit. After the physical design 338 of the circuit has been completed, the final netlist is generated by analysis and optimization tools that verify the correctness and performance of the design. These tools perform various checks on the netlist to ensure that it meets the design specifications, such as functional correctness, timing requirements, power consumption, and area constraints. The final netlist typically includes information about the components used in the circuit, such as gates, flip-flops, input/output buffers, and other elements. It also includes information about the interconnections between the components, such as the routing of wires and the positioning of components on the chip or board. The final netlist may serve as the basis for generating the fabrication masks that are used in the manufacturing of the chip or board. It represents the complete physical implementation of the circuit, and it is used to ensure that the final product meets the original design specifications with respect to performance, power consumption, and area requirements.

Parasitics in a circuit refer to any unintended or unwanted element or effect that arises due to the physical nature of the circuit components or layout. For example, the unintended or unwanted elements can include parasitic capacitance, in addition to other such elements including resistances, inductances, cross-talk, etc. Parasitics can have a significant impact on performance of the circuit, causing degraded signal quality, increased power consumption, and even failure of the circuit. Therefore, it is essential to include parasitics in the final netlist to ensure that the physical implementation of the circuit meets the design specifications. The final netlist is generated after performing several post layout analysis steps, including extraction of parasitic elements. Parasitic extraction refers to the process of analyzing the electrical behavior of the circuit to determine the effects of parasitic elements.

The final netlist with parasitics 345 can be used to analyze the actual die 351. That is, as used herein parasitics such as the parasitics 345 can refer to undesired and/or non-ideal effects that arise due to the physical components and interconnections within the circuit. As is generally understood, the parasitics can impact or dictate the final capacitance, inductance, and/or resistance, among other intrinsic properties of a circuit such as a digital logic circuit. The structure created by the final netlist with parasitics 345 of the die 351 can be tested by performing a tester power measurement 355 using the ATPG 337 patterns. First, the standby power can be measured. Next, the pattern can be launched and the power increase associated with the pattern can be captured. The pattern can target the whole intellectual property (“IP”) core or some part of it; for example, a partition, specific IP within the IP core, some power or clock domains, etc. Other IP cores can remain static and may not interfere with the measurement. The tester power measurement 355 can result in a scan-based power measurement 363.

At this point, particularly accurate power figures may be obtained. In order to provide the final functional power estimation, the scan based power measurement 363 is used as a reference and correlated to the scan based power estimation 361. The correlation 365 between the scan based power estimation 361 and the scan based power measurement 363 provides a calibration factor 357 that can be used to fine-tune other power estimations. As an example, the calibration factor 357 is a ratio between the scan based power measurement 363 (which is measured) and the scan based power estimation 361 (which is estimated). This calibration factor 357 can be applied to the gate level functional power estimation 353, resulting in a correlated functional power 359. The calibration factor 357 can mitigate or reduce an error in the estimation of the gate level functional power estimation and subsequent gate level functional power estimations. Further, the calibration factor 357 can be applied to the RTL power estimation 335, resulting in a more accurate RTL based functional power estimation 339. Subsequent performance of the system can use the calibration factor 357 and the RTL based functional power estimation 339 to be more accurate than using the RTL based functional power estimation 339 alone. Likewise, using the calibration factor 357 with the gate level functional power estimation 353 can be more accurate than using the gate level functional power estimation 353 alone. While described herein as an individual calibration factor 357, in some embodiments there may be a plurality of calibration factors. For instance, there may be a plurality of calibration factors associated with respective portions or partitions of an IP core. For example, some IP or partitioned IP cores can have significantly higher working frequency and/or a higher percentage of the LVT cells, or be more cell power dominated (vs. interconnect power) or have higher cell density, etc. In such an example, higher accuracy can be achieved by applying different calibration factors to different portions or partitions. Accordingly, some IP or partitioned Ips can have different (e.g., higher or lower) performance characteristics and therefore has different calibration factors associated therewith.

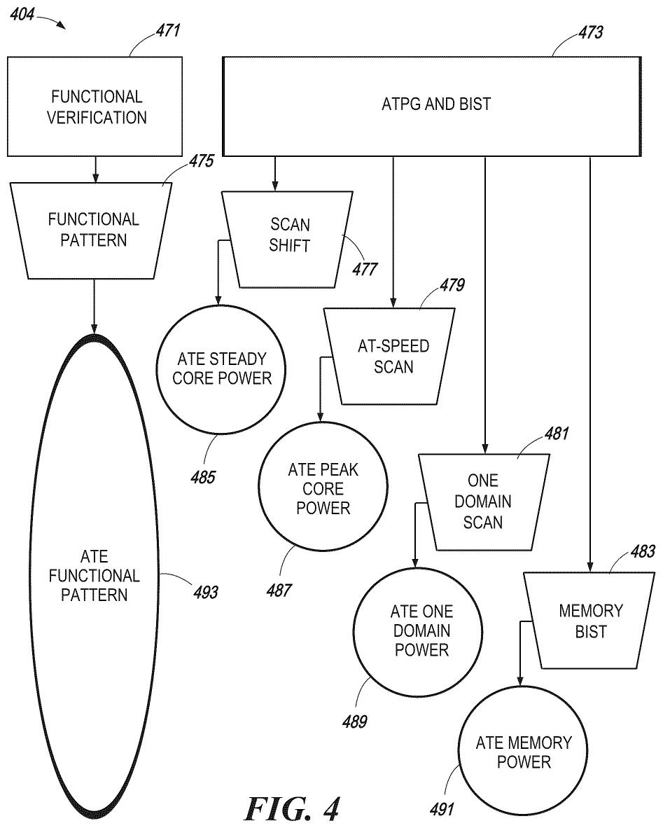

FIG. 4 illustrates an example diagram 404 for a method of power emulation and estimation in accordance with some embodiments of the present disclosure. Having both the real or measured (e.g., scan based power measurement 363 in FIG. 3B) and estimated (e.g., scan based power estimation 361 in FIG. 3B) scan-based power figures available, a correlation may be made for an IP in a whole or for a portion of the IP, such as clock domain, power domain, hierarchical module, etc. (each of which may be pattern dependent). The correlation can be made for different process corners (such as slow, typical, etc.). This feature can allow for efficient process shift planning and implementation for the yield, as well as performance and power optimization. The calibration factor (e.g., calibration factor 357 in FIG. 3B) obtained from the correlation can be applied to both RTL and Gate Level based estimations. Since the scan-based switching profile is brought close to the functional one, the estimation, amended by the factor, would represent the closest possible approximation to a real functional power. For example, a pattern of higher or lower switching activity can be generated due to adjustable control of the parameters of the ATPG. Further, current ATPG tools and scan controllers can allow for a broad variety of patterns. However, in addition to that, different DFT modes can also be useful to create a detailed profile per IP asset.

As is illustrated in FIG. 4, a functional verification 471 (similar to function verification 331 in FIG. 3A) can be used as an input to a functional pattern 475, which in turn is used as an input into an automatic testing equipment (ATE) functional pattern 493. Thus, in contrast to previous approaches, where planning and/or executing the ATE functional patterns are time consuming, computationally intensive, and/or may cost a lot of ATE time (and thereby increase product cost), the approaches herein are flexible and relatively computationally inexpensive. Further, the functional patterns of the ATE may include debugging and/or manual work to properly tune. As specific examples of this, an ATPG and built-in self-test (BIST) 473 can include a scan shift 477, an at-speed scan 479, a one domain scan 481, and/or a memory BIST 483, respectively, which are portions of the ATPG and BIST 473 superset. In one example where there is no shift, ATE steady core power 485 refers to a static (leakage) power. The scan shift 477 can also be used to generate and/or adjust an intensity of switching activity in both flip-flops (FFs) and logic domains. The at-speed scan 479 can refer to a power measurement at an ATE peak core power pattern 487. As an example, multi-capture AC scans can allow peak power measurement particularly close to functional scenarios. The one domain scan 481 can refer to power measurement that occurs during an ATE one domain power pattern 489. The one domain scan can include scans that target only FFs and logic in a particular clock domain, power domain, or specific IP partition. Typically, the FFs and logic are isolated from the memories and mixed signal Ips. To be clear, embedded memory is not usually scanned nor is the memory affected by the scan. However, in some embodiments, an additional mode may be deployed to determine an amount of power consumed by a controller of a memory BIST 483 itself, e.g., when measuring power using the BIST 483. The memory BIST 483 can refer to a memory power measurement that occurs during MBIST power pattern 491. Similar techniques that applied to MBIST may help to correlate the power of other arrays such as register files, latch arrays, CAM etc., In at least some cases, once correlated with specific technology nodes and particular IP, the factor may be applied to all subsequent projects done in the same node and IP versions with increased accuracy.

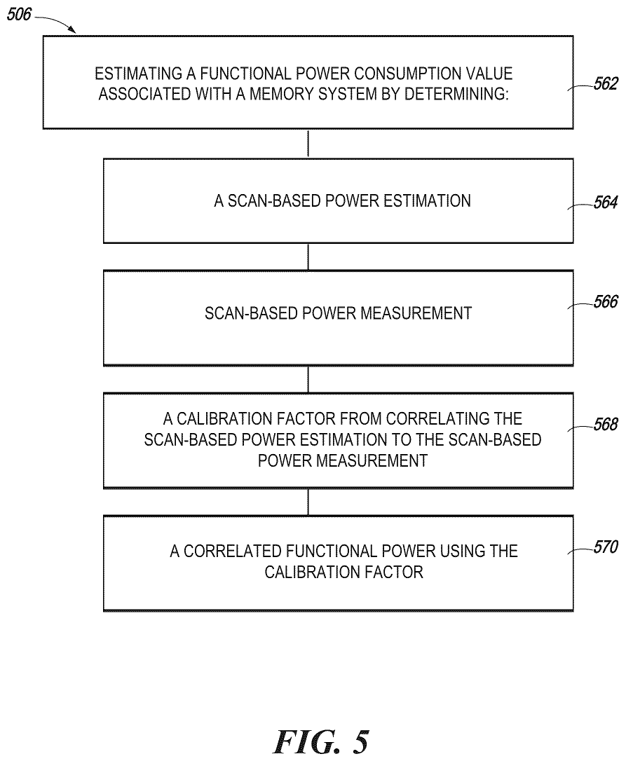

FIG. 5 illustrates an example method 506 for power emulation and estimation in accordance with some embodiments of the present disclosure. The method 506 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 506 is performed by one or more components of the computing system 100 of FIG. 1 and/or one or more components of the system 202 in FIG. 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 562, a functional power consumption value associated with a memory system can be estimated based on operations including 564, 566, 568, and 570 described further below. For instance, a functional power consumption value can be determined based on results of each of the operations at 564, 566, 568, and 570 as described below.

At operation 564, a scan-based power estimation can be determined. The scan-based power estimation can be determined using inputs from a simulation.

At operation 566, a scan-based power measurement can be determined. The scan-based power measurement can be determined using a measurement from a tester that tests the silicon of a die. The silicon of the die can be generated based on a final netlist, as described herein. The final netlist can be created based on a synthesis netlist, as described herein.

At operation 568, a calibration factor can be determined. The calibration factor can indicate or demonstrate the difference between an estimation of the power and an actual measurement of the power based on using the same parameters. In this way, the calibration factor can adjust a functional power estimation closer to the actual value of a measurement without needing to measure the functional actual power value. At operation 570, the functional power consumption value can be estimated by determining a correlated functional power using the calibration factor. The correlated functional power can be a more accurate estimation than an estimation determined without using the calibration factor.

In some examples, the functional power consumption value can include determining functional switching activity vectors using register-transfer level (RTL) data and functional verification data or a netlist and the functional verification data. In embodiments employing the netlist and the functional verification data, the netlist can be a synthesis netlist or a final netlist. For instance, the functional switching activity vectors can be determined using register-transfer level (RTL) data and functional verification data. Using the RTL data can include estimating the power consumption value by using a synthesis operation to map the RTL data into gates and insert scan chains. In some examples, estimating the power consumption includes measuring a sample power. The sample power can be measured using a tester. The tester can use various test patterns generated by an automatic test pattern generator (ATPG) or other pattern generators. For example, other pattern generators can include an MBIST or other such pattern generator sources. In some examples, the measurement of the sample power includes measuring standby power. In some examples, the measurement of the sample power includes launching, subsequent to measurement of the standby power, a pattern. The pattern can be one of the ATPG patterns, an MBIST pattern, and/or another type of dynamic pattern. In some examples, the pattern targets at least a portion of an intellectual property (IP) circuit.

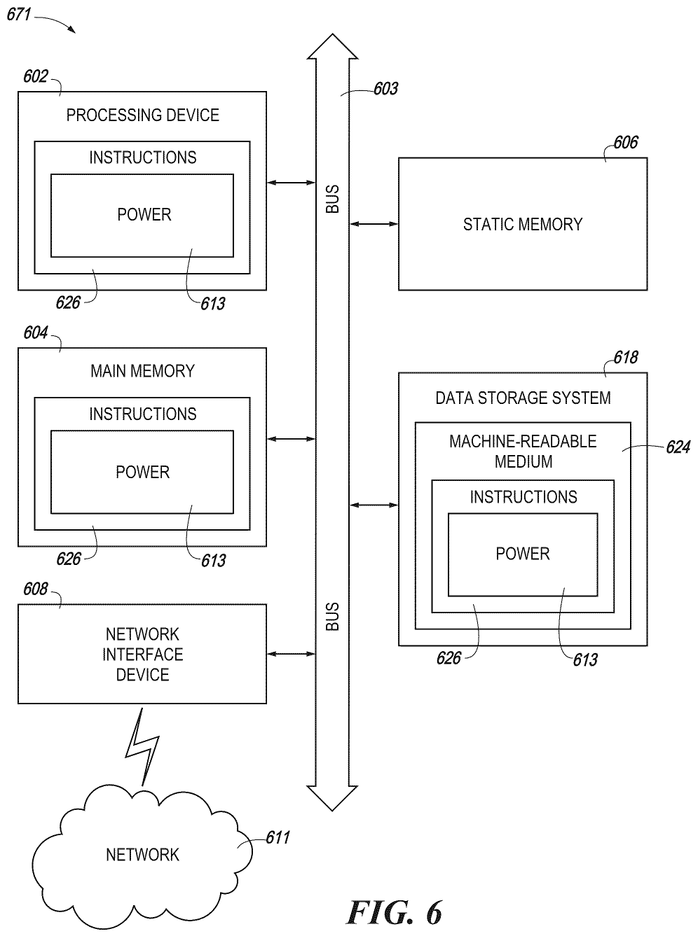

FIG. 6 is a block diagram of an example computer system 671 in which embodiments of the present disclosure may operate. For example, FIG. 6 illustrates an example machine of a computer system 671 within which a set of instructions, for causing the machine to perform any one or more of the methodologies discussed herein, can be executed. In some embodiments, the computer system 671 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the power component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 671 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage system 618, which communicate with each other via a bus 603.

The processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 671 can further include a network interface device 608 to communicate over the network 611.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 671, the main memory 604 and the processing device 602 also constituting machine-readable storage media. The machine-readable storage medium 624, data storage system 618, and/or main memory 604 can correspond to the memory sub-system 110 of FIG. 1.

In one embodiment, the instructions 626 include instructions to implement functionality corresponding to a power component 613 (e.g., the power component 113 of FIG. 1). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including solid state drives (SSDs), hard disk drives (HDDs), floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
estimating a functional power consumption value associated with a memory system by determining:
a scan-based power estimation;
a scan-based power measurement;
a calibration factor from correlating the scan-based power estimation to the scan-based power measurement; and
a correlated functional power using the calibration factor.

2. The method of claim 1, further comprising estimating the functional power consumption value by determining functional switching activity vectors using:
register-transfer level (RTL) data and functional verification data; or
a netlist and the functional verification data.

3. The method of claim 2, wherein using the RTL data includes estimating the functional power consumption value by using a synthesis operation to map the RTL data into gates and insert scan chains.

4. The method of claim 1, wherein the scan-based power estimation is determined using a scan pattern simulation.

5. The method of claim 4, wherein the scan pattern simulation is customizable.

6. The method of claim 5, wherein the scan pattern simulation is customizable to one of:
a high power pattern;
a low power pattern;
a quantity of patterns per chain;
a quantity of chains;
a quantity of the chains per pattern; or
any combination thereof.

7. The method of claim 5, wherein the scan pattern simulation is customizable with respect to one of:
a clock value;
a clock speed;
a clock domain;
a quantity of power domain; or
any combination thereof.

8. The method of claim 1, wherein determining the scan-based power measurement comprises measuring a sample power.

9. The method of claim 8, wherein the measured sample power comprises measuring standby power.

10. The method of claim 9, wherein the measured sample power comprises, launching, subsequent to measurement of the standby power, a pattern.

11. The method of claim 10, wherein the pattern targets at least a portion of an intellectual property (IP) circuit.

12. A method comprising:
estimating a functional power consumption value associated with a memory system by:
determining a scan-based power measurement using a tester to apply automatic test pattern generator (ATPG) patterns to a silicon die;
determining a scan-based power estimation using simulation vectors;
correlating the scan-based power measurement to the scan-based power estimation resulting in a calibration factor; and
using the calibration factor to determine a final functional power estimation.

13. The method of claim 12, wherein the functional power consumption value from the estimating comprises using the calibration factor by applying the calibration factor to a gate level functional power estimation and an RTL-based power estimation.

14. The method of claim 12, wherein the calibration factor mitigates an error in subsequent gate level functional power estimations.

15. The method of claim 12, comprising adjusting the scan-based power measurement by adjusting power parameters associated with an intellectual property (IP) component, wherein the power parameters are adjusted using:
a scan shift operation; and
an at-speed scan operation.

16. The method of claim 15, further comprising adjusting the scan-based power measurement by adjusting power parameters associated with an intellectual property (IP) component, wherein the power parameters are adjusted using:
a single domain scan operation; and
an memory built-in self-test (MBIST) operation.

17. The method of claim 16, wherein the single domain scan operation isolates FFs and logic from a memory and mixed signal Ips.

18. The method of claim 12, wherein the calibration factor modifies a subsequent functional power estimation to the final functional power estimation.

19. An apparatus, comprising:
a memory; and
a processing device coupled to the memory, the processing device configured to:
estimate a functional power consumption value associated with a memory system by determining:
functional switching activity vectors using register-transfer level (RTL) data and functional verification data;
a gate level functional power estimation, wherein the gate level functional power estimation uses a plurality of functional vectors;
a scan-based power estimation, wherein the scan-based power estimation uses scan vectors from a scan pattern simulation, wherein the scan pattern simulation is generated using a final netlist;
a scan-based power measurement, wherein the scan-based power measurement uses the final netlist to determine a layout of a silicon die and the silicon die is tested to determine the scan-based power measurement; and
a calibration factor based on a comparison of the scan-based power estimation and the scan-based power measurement, wherein the calibration factor is used with the gate level functional power estimation to adjust the gate level functional power estimation, a RTL based functional power estimation, or both.

20. The apparatus of claim 19, wherein power parameters associated with the estimating of the functional power consumption value are adjusted using:
a scan shift operation;
an at-speed scan operation;
a single domain scan operation; and
an memory built-in self-test (MBIST) operation.
